(19) United States
(12) Patent Application Publication
(10) Pub. No.: US 2008/0124596 A1
(43) Pub. Date: May 29, 2008

(54) Feedback-based control of a PEM fuel cell for high temperature protection

(75) Inventors: Jason R. Kolodziej, West Henrietta, NY (US); David A. Arthur, Honeoye Falls, NY (US); Seth E. Lerner, Honeoye Falls, NY (US); Abdullah B. Alp, West Henrietta, NY (US)

Correspondence Address: MILLER IP GROUP, PLC;GENERAL MOTORS CORPORATION, 42690 WOODWARD AVENUE, SUITE 200, BLOOMFIELD HILLS, MI, 48304, US

(73) Assignee: GM Global Technology Operations, Inc., Detroit, MI (US)

(21) Appl. No.: 11/592,589

(22) Filed: Nov. 3, 2006

(51) Int. Cl. H01M 8/04

(52) U.S. Cl. 429/24

(57) ABSTRACT

A fuel cell system that employs an algorithm for limiting the current output from a fuel cell stack using feedback during high stack temperature operation. The system includes a PID controller that receives an error signal that is the difference between the cooling fluid output temperature from the stack and a predetermined temperature value. The algorithm detects whether the cooling fluid output temperature goes above a predetermined temperature value, and if so, calculates a proportional gain component and an integral gain component that sets the proportional and integral gains of the PID controller. Based on the proportional gain component, the integral gain component and the error signal, the algorithm generates a total current allowed, and sets the maximum current draw from the stack accordingly. The rate of the rise or fall of the allowed current from the stack from the actual current is limited to provide a smooth transition.

### BACKGROUND OF THE INVENTION

1. Field of the Invention

This invention relates generally to a fuel cell system that employs a sub-system for preventing a fuel cell stack from overheating and, more particularly, to fuel cell system that employs an algorithm that limits the output power of a fuel cell stack to prevent the temperature of the stack from going above a predetermined value.

2. Discussion of the Related Art

Hydrogen is a very attractive fuel because it is clean and can be used to efficiently produce electricity in a fuel cell. A hydrogen fuel cell is an electro-chemical device that includes an anode and a cathode with an electrolyte therebetween. The anode receives hydrogen gas and the cathode receives oxygen or air. The hydrogen gas is dissociated in the anode to generate free hydrogen protons and electrons. The hydrogen protons pass through the electrolyte to the cathode. The hydrogen protons react with the oxygen and the electrons in the cathode to generate water. The electrons from the anode cannot pass through the electrolyte, and thus are directed through a load to perform work before being sent to the cathode.

Proton exchange membrane fuel cells (PEMFC) are a popular fuel cell for vehicles. The PEMFC generally includes a solid polymer electrolyte proton conducting membrane, such as a perfluorosulfonic acid membrane. The anode and cathode typically include finely divided catalytic particles, usually platinum (Pt), supported on carbon particles and mixed with an ionomer. The catalytic mixture is deposited on opposing sides of the membrane. The combination of the anode catalytic mixture, the cathode catalytic mixture and the membrane define a membrane electrode assembly (MEA). MEAs are relatively expensive to manufacture and require certain conditions for effective operation.

Several fuel cells are typically combined in a fuel cell stack to generate the desired power. For example, a typical fuel cell stack for a vehicle may have two hundred or more stacked fuel cells. The fuel cell stack receives a cathode input gas, typically a flow of air forced through the stack by a compressor. Not all of the oxygen is consumed by the stack and some of the air is output as a cathode exhaust gas that may include water as a stack by-product. The fuel cell stack also receives an anode hydrogen input gas that flows into the anode side of the stack.

The fuel cell stack includes a series of bipolar plates positioned between the several MEAs in the stack, where the bipolar plates and the MEAs are positioned between two end plates. The bipolar plates include an anode side and a cathode side for adjacent fuel cells in the stack. Anode gas flow channels are provided on the anode side of the bipolar plates that allow the anode reactant gas to flow to the respective MEA. Cathode gas flow channels are provided on the cathode side of the bipolar plates that allow the cathode reactant gas to flow to the respective MEA. One end plate includes anode gas flow channels, and the other end plate includes cathode gas flow channels. The bipolar plates and end plates are made of a conductive material, such as stainless steel or a conductive composite. The end plates conduct the electricity generated by the fuel cells out of the stack.

A fuel cell system typically includes a thermal sub-system for cooling the fuel cell stack to a desired operating temperature. The thermal sub-system includes a pump that pumps a cooling fluid through a coolant loop outside of the stack and cooling fluid flow channels provided within the bipolar plates. A radiator typically cools the hot cooling fluid that exits the stack before it is sent back to the stack.

Various components in the fuel cell stack, such as the membranes, may be damaged if the temperature of the stack increases above a certain materials transition temperature, such as 85° C. Therefore, fuel cell systems typically employ a cooling fluid temperature monitoring sub-system that monitors the temperature of the cooling fluid flowing out of the stack so as to prevent the temperature of the stack from increasing above a predetermined temperature. Various factors could cause the temperature of the fuel stack to increase above the predetermined temperature, such as operating the stack at a high load for an extended period of time in a high ambient temperature environment.

In current fuel cell system designs, the cooling fluid temperature is typically measured at the cooling fluid outlet from the stack by a temperature sensor. If the cooling fluid were flowing, the sensor would provide a signal of stack overheating. If the cooling fluid, and thus the fuel cell stack, becomes overheated, the system would take preventative measures, such as shut down the stack to protect it. However, there are potential failure modes where the system might not detect stack overheating, or detect a false overheating condition causing an unnecessary system shut down. These potential failure modes include cooling fluid pump failure, cooling fluid loss, cooling fluid flow blockage and cooling fluid outlet temperature sensor failure. If the system does not detect an overheat condition of the fuel cell stack, the stack membranes may become damaged. However, if the system falsely detects an overheat condition and shuts the system down, system reliability will be lower.

It is known in the art to limit the output power of the stack when an overheat condition is detected. In one application, a look-up table is employed that provides a maximum stack output current depending on the temperature of the cooling fluid. For example, if the temperature of the cooling fluid output from the stack goes above 82° C., then the output current of the stack may be limited to one current value that is less than the maximum stack current. If the temperature of the cooling fluid continues to increase, the output current of the stack may be further limited so as to prevent the temperature of the stack from exceeding the temperature that may damage the membranes. Once the cooling fluid temperature does fall below the maximum desired temperature, the look-up table simply allows the maximum available current from the stack to return to the stack maximum. If the request for power has not changed, the heat rejection capability of the cooling fluid sub-system is not able to meet the rejection demand, and the cooling fluid temperature will then rise above the predetermined value again. By employing a look-up table for this purpose, each change in the stack current limit is a step from a previous change that does not provide for a smooth transition between one current limit and another that can be felt by the vehicle driver. Further, this process creates an oscillation in stack load, temperature and stack relative humidity, which is bad for stack durability and performance.

### SUMMARY OF THE INVENTION

In accordance with the teachings of the present invention, a fuel cell system is disclosed that employs an algorithm for limiting the current output from a fuel cell stack using feedback during high stack temperature operation. The system includes a PID controller that receives an error signal that is the difference between the cooling fluid output temperature from the stack and a predetermined temperature value. The algorithm detects whether the cooling fluid output temperature from the stack goes above a predetermined temperature value, and if so, calculates a proportional gain component and an integral gain component that sets the proportional and integral gains of the PID controller. Based on the proportional gain component, the integral gain component and the error signal, the algorithm generates a total current allowed, and sets the maximum current draw from the stack accordingly. The rate of the rise or fall of the allowed current from the stack from the actual current is limited to provide a smooth transition.

Additional features of the present invention will become apparent from the following description and appended claims, taken in conjunction with the accompanying drawings.

### BRIEF DESCRIPTION OF THE DRAWINGS

FIG. 1 is a general schematic block diagram of a fuel cell system;

FIG. 2 is a schematic block diagram of a control system including a PID controller for setting a maximum output current from a fuel cell stack based on the stack temperature, according an embodiment of the present invention; and

FIG. 3 is a flow chart diagram showing the operation of an algorithm employed in the control system shown in FIG. 2.

### DETAILED DESCRIPTION OF THE EMBODIMENTS

The following discussion of the embodiments of the invention directed to a fuel cell system employing a control system for limiting the stack output current based on stack temperature is merely exemplary in nature, and is in no way intended to limit the invention or its applications or uses.

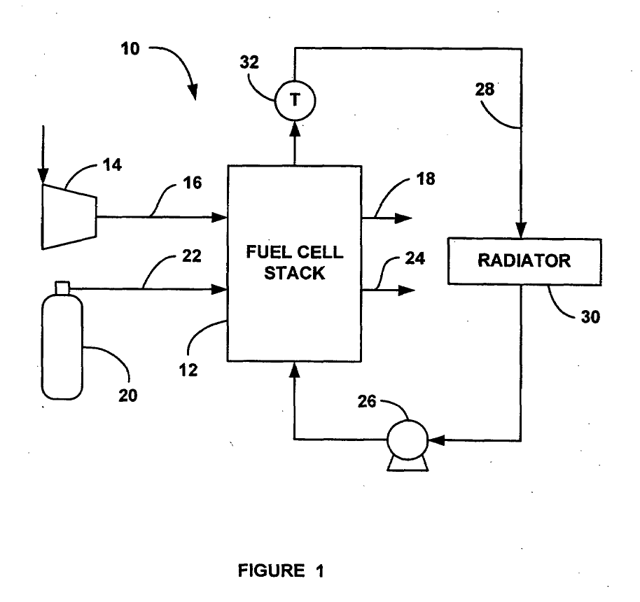

FIG. 1 is a schematic block diagram of a fuel cell system 10 including a fuel cell stack 12. A compressor 14 provides a flow of air to the cathode side of the stack 12 on a cathode input line 16. A cathode exhaust gas is output from the stack 12 on a cathode output line 18. A hydrogen source 20 provides a flow of hydrogen to the anode side of the fuel cell stack 12 on an anode input line 22. An anode exhaust gas is output from the stack 12 on an anode output line 24. The fuel cell system 10 also includes a pump 26 that pumps a cooling fluid through cooling fluid flow channels in the fuel cell stack 12 and a coolant loop 28 outside of the fuel cell stack 12, as is well understood to those skilled in the art. The heated cooling fluid from the fuel cell stack 12 is sent to a radiator 30 where it is reduced in temperature before being sent back to the fuel cell stack 12. The radiator 30 may include a fan (not shown) that drives cooling air through the radiator 30 to provide the cooling, as is well understood in the art. A temperature sensor 32 measures the temperature of the cooling fluid as it exits the stack 12. The system 10 also includes a three-way valve 78 that allows the cooling fluid to by-pass the radiator 30 for certain operating conditions where it is undesirable to cool the cooling fluid.

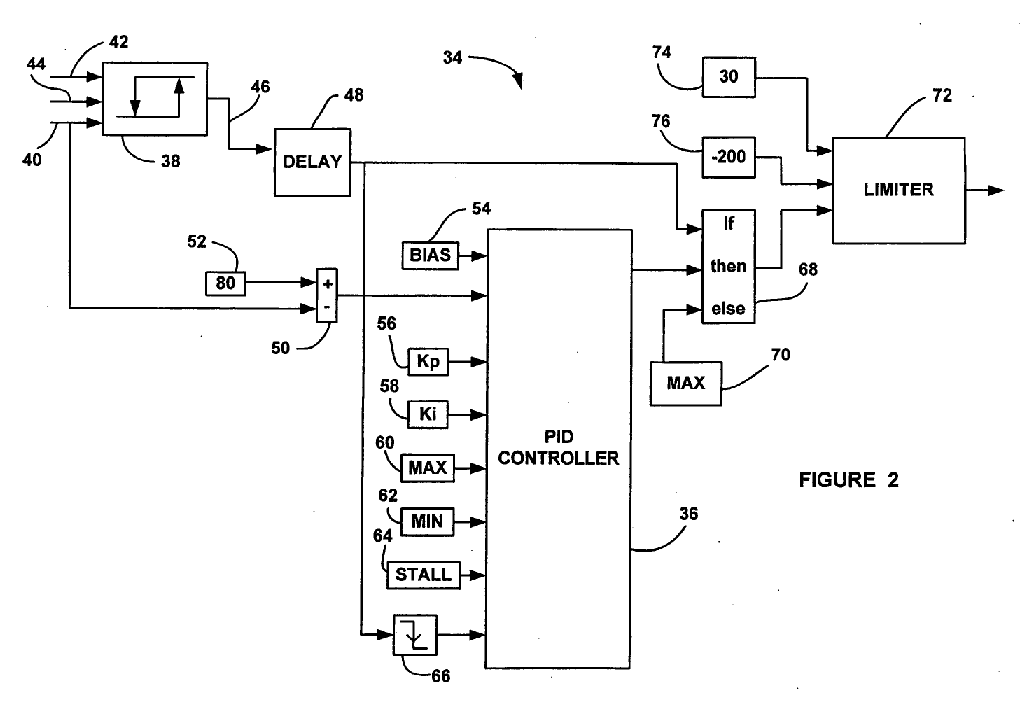

FIG. 2 is a schematic block diagram of a control system 34 for limiting the current output of the fuel cell stack 12 if the temperature of the cooling fluid out of the fuel cell stack 12 goes above a predetermined temperature value so that the temperature of the stack 12 does not increase to a level that could damage the cell membranes. The control system 34 employs a proportional-integral-derivative (PID) controller 36 that determines the maximum current allowed from the stack 12 based on the temperature of the cooling fluid, as will be discuss in more detail below.

The temperature of the cooling fluid measured by the cooling fluid sensor 32 is sent to a hysteresis controller 38 on line 40. The hysteresis controller 38 also receives an upper temperature limit on line 42 and a lower temperature limit on line 44. In one non-limiting embodiment, the upper limit is 82° C. and the lower limit is 80° C. If the cooling fluid temperature goes above the upper temperature limit, then the controller 38 outputs a high signal on line 46 to a delay circuit 48. A high signal on the line 46 is an enable signal for the control system 34. Once the temperature of the cooling fluid goes above the upper temperature limit, the output from the controller 38 will stay high until the temperature of the cooling fluid goes below the lower temperature limit, and once the temperature of the cooling fluid goes below the lower temperature limit, the output from the controller 38 will stay low until the temperature of the cooling fluid goes back above the upper temperature limit. The delay circuit 48 can be used to delay the time from when the temperature does go above the upper limit until when the control system 34 actually limits the current output of the stack 12. In most cases, the delay will be set to zero, where the delay circuit 48 acts as a pass-through.

The temperature signal from the temperature sensor 32 on the line 40 is also sent to an error circuit 50 that subtracts the temperature signal from a predetermined temperature value, for example, 80° C., provided by block 52 to generate an error signal. The temperature value does not need to be the same as the lower temperature limit, but typically will be the same or about the same. The error signal is sent to the PID controller 36 that attempts to reduce the error signal to be zero or below by selectively controlling the maximum output current from the stack 12, assuming that the control system 34 has been enabled.

A bias value is applied to the PID controller 36 from a bias block 54. The bias value is the stack current from which the allowable stack current is reduced, and is typically the maximum current that the fuel cell stack 12 can produce, such as 450 amps. A predetermined proportional gain value Kp is applied to the PID controller 36 from box 56 and a predetermined integral gain value Ki is applied to the PID controller 36 from box 58. The derivative control of PID controller 36 is not used, i.e., the derivative gain value is set to zero. In one non-limiting example, the predetermined proportional gain value is 50 and the predetermined integral gain value is 3 for one specific application.

The bias value from the bias block 54 is used as a starting point for reducing the current output of the stack 12 depending on the value of the error signal. The maximum amount of current that can be drawn from the stack 12 is provided at block 60 and the minimum amount of current that has to be drawn from the stack 12 is provided at block 62. In one non-limiting embodiment, the maximum current is 450 amps and the minimum current is 40 amps. A stall command can be provided by stall block 64, which causes the output of the PID controller 36 to be maintained, as long as the output of the stall block 64 is high. Various operating conditions may exist where such a feature is desirable.

The output of the delay circuit 48 is applied to a reset circuit 66. When the output of the delay circuit 48 goes from high to low, the reset circuit 66 provides a high signal to the controller 36 on the falling edge of the high signal to the low signal from the delay circuit 48. The PID controller 36 will then reset its output to the bias value from the block 54, reset the integral gain term to zero and reset all of its parameters for initializing a future PID control.

The output of the delay circuit 48 is also sent to an “if” input of a Boolean circuit 68. If the output of the delay circuit 48 is low, meaning that the control system 34 has not been enabled, then the circuit 68 will output the maximum possible current from the stack 12, which is provided by an “else” input to the Boolean circuit 68 from block 70. If, however, the output of the delay circuit 48 is high, then the circuit 68 selects a “then” input to the Boolean circuit 68, which is provided by the PID controller 36 to set the maximum output current from the stack 12 that is calculated by the PID controller 36 based on the inputs above so as to reduce the temperature of the stack 12. The maximum current allowed from the stack 12 is output from the circuit 68 to a rate limiter circuit 72. The rate limiter circuit 72 limits how fast the current output of the stack 12 can change, whether it is increasing or decreasing. In this non-limiting example, the rising current rate, i.e., how fast the maximum current output from the stack 12 can increase, is limited to 30 amps per second as provided by block 74, and the falling current rate, i.e., how fast the maximum current output from the stack 12 can decrease, is limited to −200 amps per second as provided by block 76. The values of the blocks 74 and 76 can be selected for different applications in different fuel cell systems.

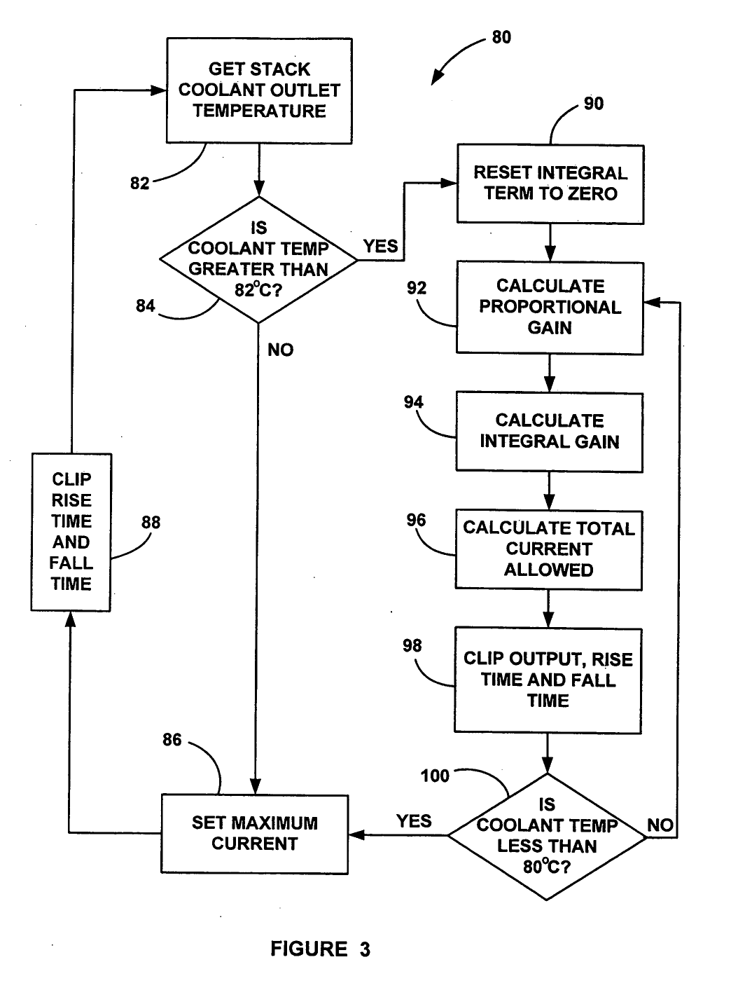

FIG. 3 is a flowchart diagram 80 showing the operation of the control system 34 as discussed above for controlling the temperature of the fuel cell stack 12. The algorithm first gets the stack cooling fluid outlet temperature from the sensor 32 at box 82. The algorithm then determines whether the cooling fluid outlet temperature is greater than the predetermined temperature value that enables the control system 34 at decision diamond 84, for example, 82° C. If the temperature of the cooling fluid is not greater than the predetermined value at the decision diamond 84, then the algorithm sets the maximum current available from the stack 12 to the maximum current the stack 12 is able to produce at box 86. The algorithm then clips the rise time rate and the fall time rate of the stack current at box 88 so that stack current does not increase or decrease faster than predetermined limits, as discussed above. The algorithm then returns to getting the stack cooling fluid outlet temperature at the box 82.

If the cooling fluid temperature is greater than 82° C. at the decision diamond 84, then the algorithm resets the integral gain component in the PID controller 36 to zero at box 90. As discussed above, the reset circuit 66 causes the PID controller 36 to reset the integral gain component to zero after the output of the delay circuit 48 goes low. However, it is only necessary to reset the integral gain component before the PID controller 36 calculates the total current allowed from the stack 12 based on the temperature, whether it is when the control system 34 is disabled, or when the control system 34 is enabled.

The algorithm then calculates the proportional gain component P at box 92 based on the error signal and the proportional gain value Kp provided at the block 56. In one non-limiting embodiment, the proportional gain component P is calculated as 80° C. minus the temperature of the cooling fluid T times 50 amps per degrees Celsius (P=(80−T)·50 A/° C.). The algorithm then calculates the integral gain component I at box 94 in the same manner based on the error signal from the error circuit 50 and the integral gain value Ki from the block 58. In one non-limiting embodiment the integral gain component I is the integral of 80° C. minus the temperature of the cooling fluid T times 3 amps per degrees Celsius per second (I=∫(80−T)·3 A/° C./sec). The algorithm then calculates the total current allowed from the stack 12 at box 96 as the bias value from the block 54 minus the proportional gain component and the integral gain component (450-P-I).

The algorithm then clips the current output from the stack 12 to be between the minimum and maximum values provided by the blocks 60 and 62 and the rise time rate and the fall time rate provided to the rate limiter circuit 72 from the blocks 74 and 76 at box 98. The algorithm then determines whether the cooling fluid temperature is less than 80° C. at the decision diamond 100, i.e., whether the error signal is zero, and if it is not, returns to calculate the proportional gain term P at the box 92 based on the error signal until the temperature does fall below 80° C. at the decision diamond 100. Each time the algorithm cycles through the current limitation loop, the integral gain component I will increase. The algorithm will then set the maximum current for the stack 12 at the box 86 and return to getting the stack cooling fluid outlet temperature at the box 82.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A system for limiting the current output from a fuel cell stack in response to a temperature of the fuel cell stack, said system comprising:
a temperature sensor for measuring the temperature of the fuel cell stack;
an error circuit for generating an error signal as the difference between the measured temperature of the fuel cell stack and a first predetermined temperature value; and
a proportional-integral-derivative (PID) controller responsive to the error signal, a bias value, a proportional gain value and an integral gain value, said PID controller calculating a proportional gain component based on the error signal and the proportional gain value and an integral gain component based on the error signal and the integral gain value, and providing a maximum allowed current from the fuel cell stack based on the bias value, the proportional gain component, and the integral gain component.

2. The system according to claim 1 further comprising an enable circuit, said enabling circuit enabling the PID controller if the measured temperature of the fuel cell stack goes above a second predetermined temperature value and then stays above a third predetermined temperature value, wherein the second and third predetermined temperature values are different.

3. The system according to claim 2 when the second predetermined temperature value is about 82° C. and the third predetermined temperature value is about 80° C.

4. The system according to claim 2 wherein the first and third predetermined temperature values are the same.

5. The system according to claim 2 further comprising a delay circuit, said delay circuit delaying enabling the PID controller for some period of time after the enable circuit enables the PID controller.

6. The system according to claim 1 further comprising a rate limiter circuit, said rate limiter circuit limiting how fast the maximum allowed current from the stack can be changed.

7. The system according to claim 1 wherein the maximum allowed current from the fuel cell stack is the bias value minus the proportional gain component minus the integral gain component.

8. The system according to claim 1 wherein the proportional gain component is the first predetermined temperature value minus the temperature of the fuel cell stack times the proportional gain value and the integral gain component is the integral of the first predetermined temperature value minus the temperature of the fuel cell stack times the integral gain value.

9. The system according to claim 8 wherein the proportional gain value is 50 and the integral gain value is 3.

10. The system according to claim 1 wherein the temperature sensor measures the temperature of a cooling fluid as it exits the fuel cell stack.

11. A system for limiting the current output from a fuel cell stack in response to a temperature of the fuel cell stack, said system comprising:
a cooling fluid loop for directing a cooling fluid through a fuel cell stack;
a temperature sensor for measuring the temperature of the cooling fluid from the fuel cell stack;
an enable circuit for enabling the system if the measured temperature of the cooling fluid goes above a first predetermined temperature value and then stays above a second predetermined temperature value, wherein the first and second predetermined temperature values are indifferent;
an error circuit for generating an error signal as the difference between the measured temperature of the cooling fluid and a third predetermined temperature value;
a proportional-integral-derivative (PID) controller responsive to the error signal, a bias value, a proportional gain value and an integral gain value, said PID controller calculating a proportional gain component based on the error signal and the proportional gain value and an integral gain component based on the error signal and the integral gain value, and providing a maximum allowed current from the fuel cell stack as the bias value minus the proportional gain component minus the integral gain component; and
a rate limiter circuit for limiting how fast the maximum allowed current from the stack can be changed.

12. The system according to claim 11 wherein the first predetermined temperature value is about 82° C. and the second and third predetermined temperature values are about 80° C.

13. The system according to claim 11 further comprising a delay circuit, said delay circuit delaying enabling the PID controller for some period of time after the enable circuit enables the PID controller.

14. The system according to claim 11 wherein the proportional gain component is the third predetermined temperature value minus the temperature of the cooling fluid times the proportional gain value and the integral gain component is the integral of the third predetermined temperature value minus the temperature of the cooling fluid times the integral gain value.

15. The system according to claim 14 wherein the proportional gain value is 50 and the integral gain value is 3.

16. A system for preventing a fuel cell stack from overheating by limiting the current output from the stack as the stack temperature increases, said system comprising:
a temperature sensor for measuring the temperature of the fuel cell stack;
an error circuit for generating an error signal as the difference between the measured temperature of the fuel cell stack and a predetermined temperature value; and
a controller responsive to the error signal and providing a maximum allowed current from the fuel cell stack that is determined based on the size of the error signal.

17. The system according to claim 16 wherein the temperature sensor measures the temperature of a cooling fluid as it exits the fuel cell stack.

18. The system according to claim 16 wherein the controller is a proportional-integral-derivative controller.

19. The system according to claim 18 wherein the proportional-integral-derivative controller calculates the maximum allowed current as a bias value minus a proportional gain component minus an integral gain component.

20. The system according to claim 16 further comprising a rate limiter circuit, said rate limiter circuit limiting how fast the maximum allowed current from the stack can be changed.
